(19) United States
(12) Patent Application Publication
(10) Pub. No.: US 2004/0254826 A1
(43) Pub. Date: Dec. 16, 2004

(54) Logistics management system and method

(76) Inventors: Wen-Xin Yang, Tu-Chen (TW); Wenbo Mao, Shenzhen (CN); Sheng-Chi Luo, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/859,253

(22) Filed: Jun. 1, 2004

(30) Foreign Application Priority Data
May 30, 2003 (TW) 92114845

(51) Int. Cl. G06F 17/60

(52) U.S. Cl. 705/8; 700/100

(57) ABSTRACT

A logistics management system includes a number of client computers (10), a provider application server (12), a number of business unit application server (16) and a database (14). The client computers provide interfaces for users to initialize the system and maintain information. The provider application server receives and handles input information, generates a production request and transmits the request to the business unit application server. The provider application server includes a document managing module (21), an in transit products monitoring module (22), a data analyzing module (23), a warehouse monitoring module (24), a data enquiring module (25), and a costs managing module (26). The database inventory data, shipment data, and supply and demand data. The business unit application server receives the production request transmitted by the provider application server, and transmits feedback on the request and enquiring requests to the provider application server. A related method is also disclosed.

### BACKGROUND OF THE INVENTION

1. Field of the Invention

The present invention relates to a computerized logistics management system and method, and particularly to a logistics management system and method for a product provider which can automatically confirm dispatched products according to inventory data, shipment data, and supply and demand data.

2. Background of the Invention

Conventional computerized systems for logistics management have focused on transportation and storage of products, but have largely ignored means for selection of dispatched products and prediction of shipment trends of the products. A conventional method for logistics management is disclosed in U.S. Pat. No. 5,631,827, issued on May 20, 1997 and entitled Logistics System for Automating Transportation of Goods. In this patent, the various transportation logistics tasks, such as order processing, order fulfillment, transportation of goods and tracking, are assigned to individual client/server objects which make up the building blocks of the computerized logistics management system. A tokenized message handling scheme allows client and server objects to share information, even where the respective data types do not match. An external processing manager provides scrip handling services to other client applications, allowing those applications to modify the performance of other program objects and to communicate with the outside world. However, the system does not efficiently deal with the problems of selecting the dispatched products systematically according to age, and does not efficiently predict any shipment trend of the product to ensure sufficient future storage of the product.

### SUMMARY OF THE INVENTION

An objective of the present invention is to provide a logistics management system for automatically confirming dispatched products according to inventory data, shipment data, and supply and demand data.

Another objective of the present invention is to provide a logistics management method for automatically confirming dispatched products according to inventory data, shipment data, and supply and demand data.

To achieve the first above-mentioned objective, a preferred embodiment of a logistics management system of the present invention comprises a plurality of client computers, a provider application server, a database and a plurality of business unit application servers. The client computers provide interfaces for users to initialize the system and maintain information. The provider application server receives and handles input information, generates production requests, and transmits the production requests to corresponding business unit application servers. The provider application server comprises a document managing module for managing uploading, downloading, and enquiring of documents; an in transit products monitoring module for monitoring in transit products and forwarders; a data analyzing module for analyzing inventory data, shipment data, and supply and demand data stored in the database; a warehouse monitoring module for monitoring products entrance, products shipment, and inventory; a data enquiring module for enquiring of relevant data according to the enquiring requests transmitted by the business unit application server; and a costs managing module for budgeting, settling balance, transferring and monitoring expenses. The database stores inventory data, shipment data, and supply and demand data. The business unit application servers receive production requests transmitted by the provider application server, and transmit feedback on the production requests and enquiring requests to the provider application server.

To achieve the second above-mentioned objective, a preferred method of the present invention for logistics management comprises the following steps: (a) receiving a purchase order of a customer; (b) determining whether an inventory of a product is sufficient; (c) generating a production request and transmitting the request to a business unit, if the inventory of the product is not sufficient; and (d) dispatching the products, if the inventory of the product is sufficient. Step (d) comprises the steps of: (d1) analyzing storage age, shipment trends, supply and demand, and a shipment forecast of the product according to inventory data, shipment data, and supply and demand data; (d2) confirming the dispatched products according to their storage age and the first-in-first-out principle; (d3) dispatching the products and monitoring shipment of the products; (d4) determining whether there is a need to replenish the inventory of the product according to the shipment trends, supply and demand, and shipment forecast of the product; and (d5) requiring a relevant business unit to produce the product if there is a need to replenish the inventory of the product.

Other objects, advantages and novel features of the present invention will be drawn from the following detailed description of the present invention with the attached drawings, in which:

### BRIEF DESCRIPTION OF THE DRAWINGS

FIG. 1 is a schematic diagram of hardware configuration of a logistics management system in accordance with the preferred embodiment of the present invention;

FIG. 2 is a schematic diagram of function modules of a provider application server of the system of FIG. 1;

FIG. 3 is a schematic diagram of sub-modules comprised in a document managing module of the provider application server;

FIG. 4 is a schematic diagram of sub-modules comprised in a data analyzing module of the provider application server;

FIG. 5 is a schematic diagram of sub-modules comprised in a warehouse monitoring module of the provider application server;

FIG. 6 is a main flowchart of a preferred method of the present invention for logistics management; and

FIG. 7 is a flowchart of details of one step of FIG. 6, namely dispatching products.

### DETAILED DESCRIPTION OF THE INVENTION

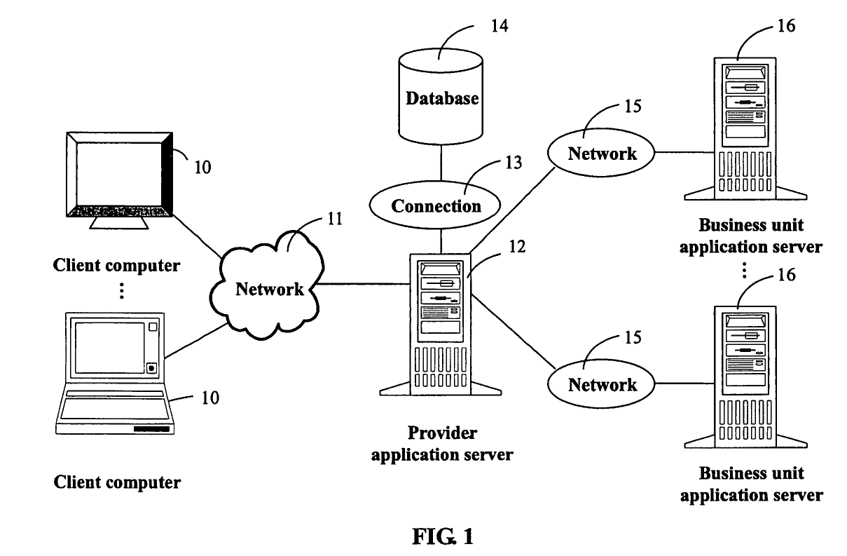

FIG. 1 is a schematic diagram of hardware configuration of a logistics management system in accordance with the preferred embodiment of the present invention. The logistics management system comprises a plurality of client computers 10, a provider application server 12, a database 14, and a plurality of business unit application servers 16. The client computers 10 are connected with the provider application server 12 via a network 11. The provider application server 12 is connected with the database 14 via a connection 13, and is connected with the business unit application servers 16 via a network 15. The networks 11, 15 can jointly or severally be the Internet, an intranet, or another suitable means of electronic communication. The connection 13 is a kind of database connection, which can be an Open Database Connectivity (ODBC), a Java Database Connectivity (JDBC), or another suitable kind of connectivity. The client computers 10 provide interfaces for users to initialize the system and maintain information. The database 14 stores inventory data, shipment data, and supply and demand data. The provider application server 12 stores function modules for receiving and handling input information, for generating production requests according to the inventory data and shipment data stored in the database 14, and for transmitting the production requests to corresponding business unit application servers 16. The provider application server 12 also receives feedback and data enquiring requests from the business unit application servers 16. That is, each business unit application server 16 receives a production request transmitted by the provider application server 12, and transmits feedback on the request and the enquiring requests to the provider application server 12. Feedback comprises a notice of receipt of the production request, and a notice of finished production.

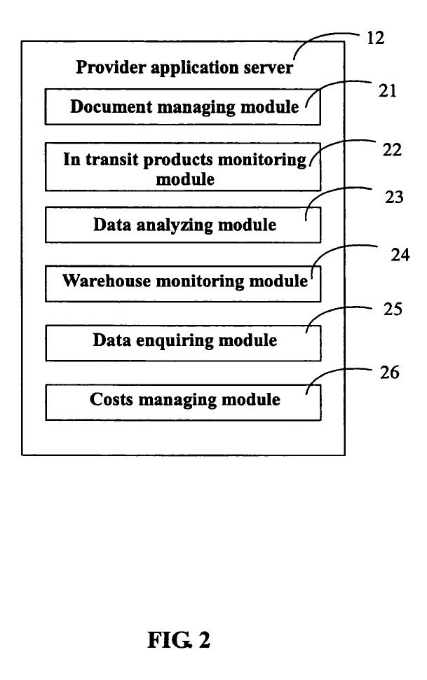

FIG. 2 is a schematic diagram of function modules of the provider application server 12. The provider application server 12 comprises a document managing module 21, an in transit products monitoring module 22, a data analyzing module 23, a warehouse monitoring module 24, a data enquiring module 25, and a costs managing module 26. The document managing module 21 is used for managing uploading, downloading and enquiring of relevant documents. The documents comprise purchase orders, production schedule tables, detailed shipment lists, bills of lading, and so on. The in transit products monitoring module 22 is used for monitoring in transit products and forwarders. The data analyzing module 23 is used for analyzing inventory data, shipment data, and supply and demand data stored in the database 14. The inventory data comprise data on production dates, entrance dates, entrance quantities, stocks quantities, and so on. The shipment data comprise data on product names, shipment dates, shipment quantities, destinations, and so on. The supply and demand data comprise data on a production capacity of each of business units, demands of each customer, a channel price of each product, and so on. The warehouse monitoring module 24 is used for monitoring product entrance, product shipment, and inventory. The data enquiring module 25 is used for enquiring of relevant data according to an enquiring request transmitted by any business unit application server 16. The costs managing module 26 is used for budgeting, settling balances, transferring sums, and monitoring expenses.

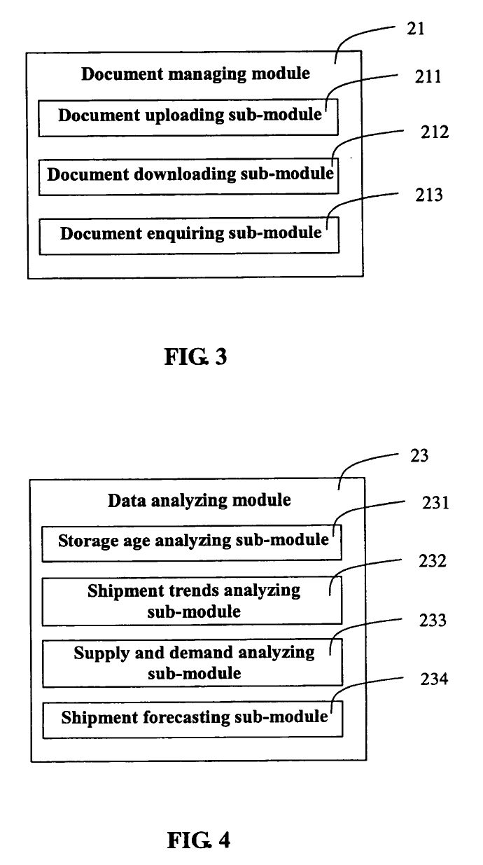

FIG. 3 is a schematic diagram of sub-modules comprised in the document managing module 21 of the provider application server 12. The document managing module 21 comprises a document uploading sub-module 211, a document downloading sub-module 212, and a document enquiring sub-module 213. The document uploading sub-module 211 is used for uploading new documents and modified documents to the provider application server 12, and for storing the documents in the database 14. The document downloading sub-module 212 is used for downloading documents from the database 14, and for transmitting the documents to any client computer 10 or any business unit application server 16. The document enquiring sub-module 213 is used for enquiring of the documents stored in the database 14.

FIG. 4 is a schematic diagram of sub-modules comprised in the data analyzing module 23 of the provider application server 12. The data analyzing module 23 comprises a storage age analyzing sub-module 231, a shipment trends analyzing sub-module 232, a supply and demand analyzing sub-module 233, and a shipment forecasting sub-module 234. The storage age analyzing sub-module 231 is used for analyzing the storage ages of items of each product according to the data on production date, entrance date, entrance quantity, stock quantity, and so on. Storage age is the period that an item of inventory has remained in a warehouse. The shipment trends analyzing sub-module 232 is used for analyzing the shipment trends of each product in the warehouse according to the data on product name, shipment date, shipment quantity, destination, and so on. The supply and demand analyzing sub-module 233 is used for analyzing the supply and demand of each product according to the data on production capacity of each business unit, demands of each customer, channel price of the product, and so on. The shipment forecasting sub-module 234 is used for forecasting the shipment of each product according to the corresponding inventory data, shipment data, and supply and demand data.

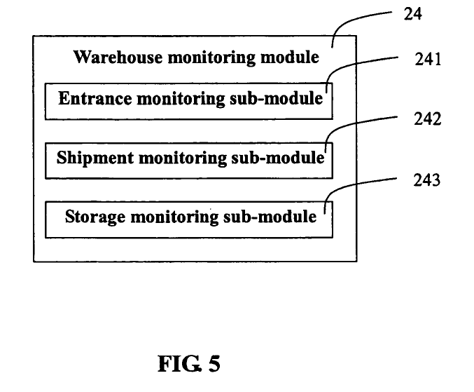

FIG. 5 is a schematic diagram of sub-modules comprised in the warehouse monitoring module 24 of the provider application server 12. The warehouse monitoring module 24 comprises an entrance monitoring sub-module 241, a shipment monitoring sub-module 242, and a storage monitoring sub-module 243. The entrance monitoring sub-module 241 is used for monitoring the entrance of the products into the warehouse. The entrance monitoring sub-module 241 monitors unloading of products, carrying of products, placing of products, quantities of products, and so on. The shipment monitoring sub-module 242 is used for monitoring selecting of products, quantities of products, loading of products, and so on. The storage monitoring sub-module 243 is used for monitoring quantities of products, retaining of products, and so on. The storage monitoring sub-module 243 is further used for generating production requests according to the inventory data and shipment data stored in the database 14, and for transmitting the production requests to corresponding business unit application servers 16. Each production request comprises data on a product name, quantity, deadline, and so on.

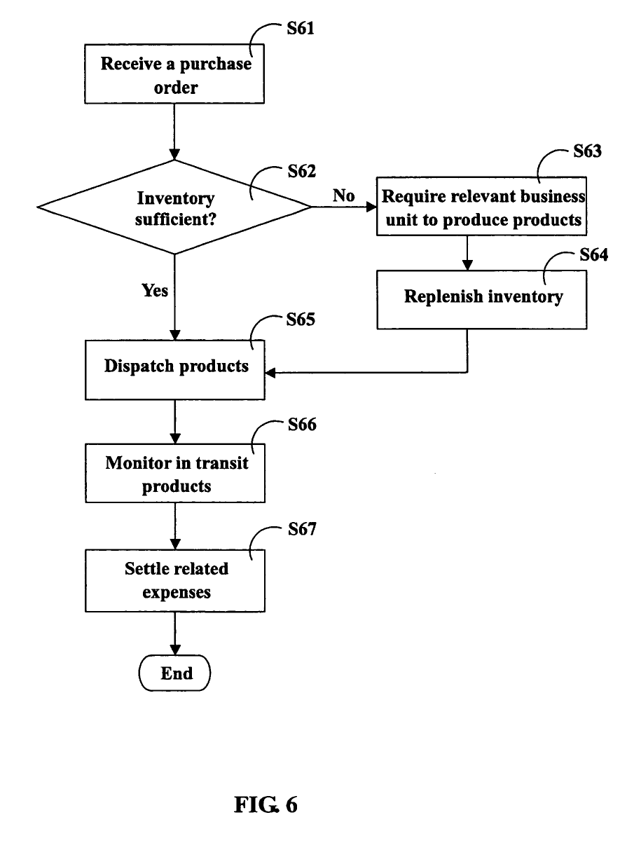

FIG. 6 is a main flowchart of a preferred method of the present invention for logistics management. In step S61, the provider application server 12 receives a purchase order of a customer. The document managing module 21 uploads the purchase order, and stores the purchase order in the database 14. In step S62, the warehouse monitoring module 24 determines whether the inventory is sufficient according to the quantity data on the purchase order. If the inventory is sufficient, the procedure goes directly to step S65 described below. If the inventory is not sufficient, in step S63, the warehouse monitoring module 24 generates a production request, and transmits the production request to a relevant business unit application server 16 so that the needed products are produced. In step S64, the corresponding business unit produces the products to replenish the inventory, whereupon the procedure goes to step S65. In step S65, the warehouse monitoring module 24 confirms that the products are ready for dispatch, and arranges dispatch of the products. In step S66, the in transit products monitoring module 22 monitors the in transit products. In step S67, the costs managing module 26 settles related expenses.

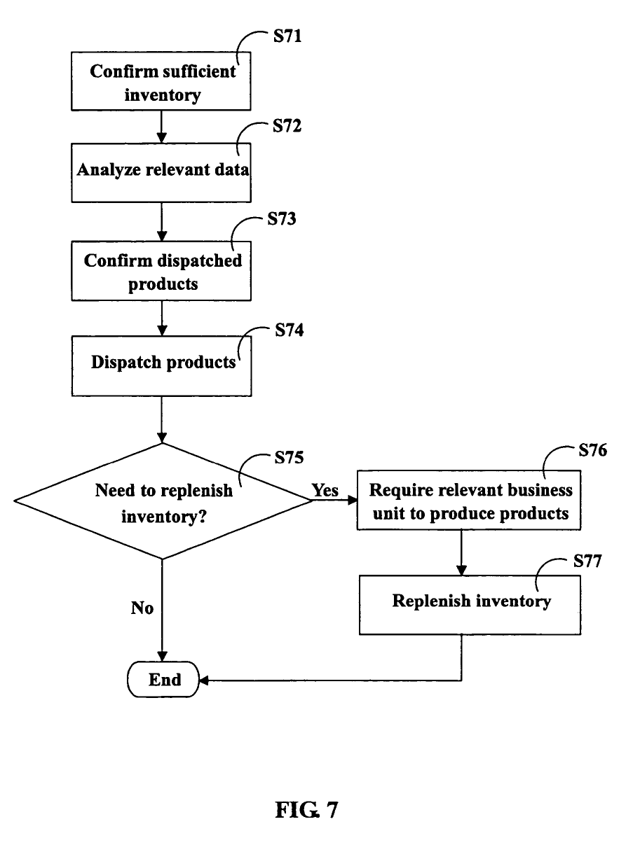

FIG. 7 is a flowchart of details of step S65 of FIG. 6, namely dispatching products. In step S71, the provider application server 12 confirms that the inventory is sufficient. In step S72, the data analyzing module 23 analyzes storage ages, shipment trends, supply and demand, and the shipment forecast of the product according to the inventory data, shipment data, and supply and demand data. In step S73, the provider application server 12 confirms the items of the product to be dispatched according to their storage ages and the first-in-first-out principle. In step S74, the warehouse monitoring module 24 dispatches the products and monitors the shipment of the products. In step S75, the provider application server 12 determines whether there is a need to replenish the inventory of the product according to the shipment trends, supply and demand, and shipment forecast of the product analyzed by the data analyzing module 23. If there is no need to replenish the inventory of the product, the procedure is ended. In step S76, if there is a need to replenish the inventory of the product, the provider application server 12 requests the relevant business unit application server 16 to produce the product. In step S77, the relevant business unit produces the product in order to replenish the inventory.

Although the present invention has been specifically described on the basis of a preferred embodiment and preferred method, the invention is not to be construed as being limited thereto. Various changes or modifications may be made to said embodiment and method without departing from the scope and spirit of the invention.

What is claimed is:

1. A logistics management system comprising a plurality of client computers, a provider application server, a database and a plurality of business unit application servers, wherein:
the client computers provide interfaces for users to initialize the system and maintain information;
the provider application server receives and handles input information, generates production requests, and transmits the production requests to corresponding business unit application servers, the provider application server comprising:
a document managing module for managing uploading, downloading, and enquiring of documents;
a data analyzing module for analyzing inventory data, shipment data, and supply and demand data stored in the database; and
a warehouse monitoring module for monitoring product entrance, product shipment, and inventory;
the database stores inventory data, shipment data, and supply and demand data; and
the business unit application servers receive the production requests transmitted by the provider application server, and transmit feedback on the production requests and enquiring requests to the provider application server.

2. The system as described in claim 1, wherein the provider application server further comprises an in transit products monitoring module for monitoring in transit products and forwarders.

3. The system as described in claim 1, wherein the provider application server further comprises a data enquiring module for enquiring of relevant data according to the enquiring requests transmitted by the business unit application servers.

4. The system as described in claim 1, wherein the provider application server further comprises a costs managing module for budgeting, settling balances, transferring sums, and monitoring expenses.

5. The system as described in claim 1, wherein the document managing module comprises:
a document uploading sub-module for uploading new documents and modified documents to the provider application server, and for storing the documents in the database;
a document downloading sub-module for downloading documents from the database, and for transmitting the documents to any client computer or any business unit application server; and
a document enquiring sub-module for enquiring of the documents stored in the database.

6. The system as described in claim 1, wherein the data analyzing module comprises:
a storage age analyzing sub-module for analyzing one or more storage ages of items of a product according to the inventory data;
a shipment trends analyzing sub-module for analyzing shipment trends of the product in a warehouse according to the shipment data;
a supply and demand analyzing sub-module for analyzing supply and demand of the product according to the supply and demand data; and
a shipment forecasting sub-module for forecasting shipment of the product according to the inventory data, shipment data, and supply and demand data.

7. The system as described in claim 1, wherein the warehouse monitoring module comprises:
an entrance monitoring sub-module for monitoring unloading of products, carrying of products, placing of products, and quantities of products;
a shipment monitoring sub-module for monitoring selecting of products, quantities of products, and loading of products; and
a storage monitoring sub-module for monitoring quantities of products and retaining of products, for generating production requests according to the inventory data and shipment data stored in the database, and for transmitting the production requests to corresponding business unit application servers.

8. The system as described in claim 1, wherein:
the inventory data comprise data on production date, entrance date, entrance quantity, and stock quantity of each product;
the shipment data comprise data on product name, shipment date, shipment quantity, and destination of each product; and
the supply and demand data comprise data on a production capacity of each of business units, demands of each customer, and a channel price of each product.

9. A logistics management method comprising the following steps:
receiving a purchase order from a customer;
determining whether an inventory of an ordered product is sufficient;
generating a production request and transmitting the production request to a business unit, if the inventory of the product is not sufficient; and
dispatching the product, if and when the inventory of the product is sufficient.

10. The method as described in claim 9, further comprising the step of monitoring in transit products.

11. The method as described in claim 9, further comprising the step of settling related expenses.

12. The method as described in claim 9, wherein the step of dispatching the product further comprises the steps of:
analyzing one or more storage ages, shipment trends, supply and demand, and a shipment forecast of the product according to inventory data, shipment data, and supply and demand data;
confirming items of the product to be dispatched, according to said storage ages and the first-in-first-out principle;
dispatching the products and monitoring shipment of the products; and
determining whether there is a need to replenish the inventory of the product according to the shipment trends, supply and demand, and shipment forecast of the product.

13. The method as described in claim 12, further comprising the step of requiring a relevant business unit to produce the product if there is a need to replenish the inventory of the product.
